(19) United States
(12) Patent Application Publication
(10) Pub. No.: US 2020/0208590 A1
(43) Pub. Date: Jul. 2, 2020

(54) PISTON AND SUPPORT METHOD FOR PISTON RING GROOVE THEREOF

(71) Applicant: Bin Zhou Donghailong Piston CO,LTD, Binzhou (CN)

(72) Inventors: Weibin ZHANG, Binzhou (CN); Xinhua ZHANG, Binzhou (CN); Jinyu JI, Binzhou (CN)

(21) Appl. No.: 16/260,081

(22) Filed: Jan. 28, 2019

(30) Foreign Application Priority Data
Dec. 27, 2018 (CN) 201811615097.1

(51) Int. Cl. F02F 3/22; F02F 3/00; F16J 1/00; F16J 9/00

(52) U.S. Cl. CPC F02F 3/22; F02F 3/003; F02F 2003/0061; F16J 9/00; F16J 1/005

(57) ABSTRACT

Disclosed are a piston and a method for a ring groove support structure thereof. The piston includes a piston head and a piston skirt connected with the piston head; a cooling oil cavity is arranged in the piston head; a position of the bottom of the cooling oil cavity close to the piston skirt is an open end and the open end is sealed through a supporting member; a cooling oil inlet and an oil drain port are arranged on the supporting member; the cooling oil inlet is in communication with the cooling oil cavity and an oil inlet channel of the cooling oil arranged in the piston skirt; the oil drain port is in communication with the cooling oil cavity and the oil drain channel arranged in the piston skirt; and the open end and the supporting member are welded.

### CROSS-REFERENCE TO RELATED APPLICATIONS

This application claims priority from Chinese Patent Application No. 201811615097.1, filed on Dec. 27, 2018. The content of the aforementioned application, including any intervening amendments thereto, is incorporated herein by reference in its entirety.

### TECHNICAL FIELD

The present invention relates to the technical field of split or integral forged piston for vehicles, and in particular to a piston and a support method for a piston ring groove thereof.

### BACKGROUND

A piston is the “heart” of an automobile engine, bears alternating mechanical load and thermal load, and is one of key components with the worst working conditions in the engine. The piston has the functions of bearing gas pressure and transmitting the gas pressure to a connecting rod through a piston pin shaft to rotate a crankshaft. Failure of the piston will result in loss of power for the engine, and even scrap of the entire engine. In recent decades, engine design and manufacturing technologies have been rapidly improved, especially for diesel engines which are developing towards high power and high load. The degree of intensification is constantly improved, and when the explosive force has exceeded 20 MPa, an aluminum piston has been gradually unable to meet the requirements. For this reason, domestic and foreign piston design manufacturers are committed to the design and development of a new piston with high reliability. Because of high strength, good plasticity, good machinability and abundant natural stock of the forged steel material, the forged steel material is used by many companies to replace the aluminum piston, especially developed countries in Europe and America, and the proportion of the forged steel pistons in heavy trucks and passenger vehicles is increasing.

In the prior art, generally, the head and the skirt of the cooling oil cavity in the forged steel piston are respectively processed, and then are combined through friction welding technology, to form a sealed oil cavity. This manufacturing method results in failure to clean welds inside the closed oil cavity, and the hard particles will fall off during the cooling oil shock, thereby increasing the risk of engine scuffing. In addition, the friction welding on the piston head and piston skirt is conducted, which has high requirements for a welding machine and welding parameters, and if the adjustment is improperly conducted, the weld defects will appear, thereby causing separation of the piston head from the piston skirt in use, and causing engine damage and even scrap of the whole locomotive. In addition, friction welding needs to consume a large amount of electricity, and wastes energy. To overcome the above technical problem, in the prior art, the piston (comprising an integral forged steel piston or a piston with steel crown aluminum skirt structure) is directly processed on the piston head, to form an inner cooling oil cavity, and the oil cavity is closed by adopting two spring steel sheets through elastic deformation; and although this method solves the above problem, the deformation of the piston ring groove is large due to the fact that the bottoms of the piston head ring groove and the ring land have no support or just have elastic support, and especially the sealing effect of the piston ring decreases sharply after the first ring groove is deformed greatly, so that the phenomenon of gas channeling, insufficient engine power, upward flow or burning of oil is caused. The spring steel sheet is directly pressed and formed, and the size range thereof varies widely, which is difficult to assemble or has a large clearance when the spring steel sheet is assembled with the oil cavity on the piston head. As a result, the spring steel sheet falls off in use, thereby damaging the piston, a cylinder liner and a cylinder body and even the whole engine.

Therefore, the problem to be urgently solved by those skilled in the art is how to provide a piston capable of meeting the sealing of the cooling oil cavity and supporting the ring groove and the ring land of the piston head.

### SUMMARY

In view of this, the present invention provides a piston structure, which solves disadvantages of low strength of the piston head ring groove and the ring land and lack of support, thereby improving the safety of the piston in use. Furthermore, the technical solution has advantages of reasonable structure and convenient processing, thereby improving the sealing of the cooling oil cavity, and avoiding the original danger due to the fact that an elastic steel sheet falls off.

To achieve the above purpose, the present invention adopts the following technical solution:

a piston structure provided in the present invention comprises a piston head and a piston skirt connected with the piston head, wherein a cooling oil cavity is arranged in the piston head, a position of the bottom of the cooling oil cavity close to the piston skirt is an open end, and the open end is sealed through a supporting member; a cooling oil inlet and an oil drain port are arranged on the supporting member; the cooling oil inlet is in communication with the cooling oil cavity and an oil inlet channel of the cooling oil arranged in the piston skirt; the oil drain port is in communication with the cooling oil cavity and the oil drain channel arranged in the piston skirt; and at least part of the open end and the supporting member are welded.

It is known from the above technical solution that compared with the prior art, the present invention discloses a piston, wherein

the open end is arranged on the piston head, a sealed cavity is formed by the open end and the supporting member, and the supporting member and the piston head are integrated as a whole. The supporting member plays the role of supporting the ring groove and the ring land of the piston head due to the fact that the supporting member and the piston head are rigidly connected, thereby reducing the deformation of the piston head ring groove during operation and increasing the safety and the reliability of the piston operation; a cooling oil inlet and an oil drain port are arranged on the supporting member; the cooling oil inlet is in communication with the cooling oil cavity and the oil inlet channel; and the oil drain port is in communication with the cooling oil cavity and the oil drain channel, so that the sealing of the cooling oil cavity is increased, thereby ensuring the cooling effect of the piston head; and however, the supporting member and the open end are welded into a whole, thereby making the supporting member and the piston head as a whole, to prevent an engine from damage due to the fact that the supporting member falls off.

Preferably, the supporting member is a steel sheet, the steel sheet is closed in the open end, and the steel sheet and the open end are welded into a whole, wherein the steel sheet is enclosed by two semi-circular steel sheets. By means of the technical solution, it is beneficial to assemble the supporting member.

Preferably, the open end comprises an inner clamping groove in a horizontal position and an outer notch formed by a vertical step surface and a horizontal step surface;

the steel sheet is enclosed by two semi-circular steel sheets, a mounting hole is formed in the middle of two steel sheets, an inner side is clamped in the inner clamping groove, and the inner side and the inner clamping groove are welded;

an outer side of the steel sheet and the vertical step surface are welded; and

the horizontal step surface and one side surface of the steel sheet are welded.

By means of the technical solution, it is beneficial to install the supporting member, and the supporting member has three stops, thereby increasing the contact area of the supporting member and the piston head, improving the assembly accuracy and increasing the fastness of the supporting member and the piston head.

Preferably, the matching clearance between the bottom of the inner clamping groove and the inner side of the steel sheet is 0 to 0.2 mm, and the matching clearance between the width of the inner clamping groove and the thickness of the steel sheet is 0.05 to 0.15 mm; and the matching clearance of the step surface and the top of the steel sheet is 0.2 to 1 mm. Through the limit of the above matching clearance, the installation requirements for the supporting member and the piston head are ensured. The stops of an inner clamping groove as well as an outer notch formed by a vertical step surface and a horizontal step surface is installed, so that the difficulty level of the welding is reduced, thereby increasing the qualified product rate of the assembled supporting member. However, the matching clearance between the steel sheet and the vertical step surface is not high, which can be closed by final welding.

Preferably, at least one pit is arranged on an inner wall surface of the open end, and a convex structure fitted with the pit is arranged on the outer circumference of the steel sheet; the oil inlet hole of the steel sheet is positioned to align with a cooling nozzle of the engine; and the positioning accuracy is increased.

Preferably, the piston head and the piston skirt are integrally connected or separately connected. The piston can be an integral forged steel piston or a steel crown aluminum skirt piston.

Preferably, the welding mode is continuous welding and multiple-spot welding. The welding of the supporting member and the open end in the present invention can be completed by adopting any kind of welding mode (brazing, laser welding, etc.); and an identical or similar solution that the supporting member and the piston head are welded into a whole recorded in the present invention shall be fell into the protection scope of the present invention.

Preferably, the supporting member is made by machining or stamping; and the technical solution of the present invention does not have high requirement for the forming of the supporting member, which can adopt different processing methods, thereby reducing the processing cost of the supporting member.

Preferably, the cooling oil cavity is made by machining or precision casting. The technical solution of the present invention only needs to process the open end in the piston head, which does not influence an original processing method for the piston head and has strong universality.

The present invention also provides a support method for a piston ring groove, comprising the following steps:

S1. processing the supporting member with corresponding size according to the size of the open end of the piston, wherein the supporting member is provided with a cooling oil inlet and an oil drain port, the size of the open side comprises an inner diameter, an outer diameter and height dimension of the open end; the open end can be processed according to pistons with different types, so that the size of the supporting member matched with the open end can be also changed correspondingly; and the size of the cooling oil inlet and drain port need be the same as the oil inlet channel and the oil drain channel of the piston;

S2. installing the supporting member processed in S1 in the open end to ensure that the cooling oil inlet is in communication with the cooling oil cavity and the oil inlet channel; and the oil drain port is in communication with the cooling oil cavity and the oil drain channel, thereby ensuring correct mounting position of each oil hole, that is, locating the mounting position of the supporting member in the piston head to prepare for subsequent welding;

S3. fully or partially welding the supporting member and the open end assembled in S2; and

S4. conducting heat treatment on the supporting member and the open end welded in S3.

It can be known form the above-mentioned technical solution that compared with the prior art, the present invention discloses a support method for a piston ring groove. The size of the supporting member is processed according to the size of the open end arranged on the piston head; and the supporting member plays the role of supporting the excircle of the piston head due to the fact that the supporting member and the piston head are rigidly connected, thereby reducing the deformation of the piston head during operation and increasing the safety and the reliability of the piston operation. The supporting member is installed by positioning the oil inlet and the oil drain port to increase the positioning accuracy during the installation process of the supporting member, thereby improving the sealing of the cooling oil cavity and ensuring the cooling effect of the piston head; and however, the supporting member and the open end are welded into a whole, thereby making the supporting member and the piston head as a whole, to prevent an engine from damage due to the fact that the supporting member falls off.

Advantageously, welds formed by welding are formed at an abutment junction between a mounting hole side and an inner clamping groove, a junction between the outside of the supporting member and an outer notch, and an abutment junction between steps and the top of the supporting member. The welding positions of the present invention are arranged on the outside of the cooling oil cavity so that the difficulty level of the welding is reduced, thereby reducing the welding cost; and the welds are not in contact with the cooling oil, so that the welds do not need to be cleaned, thereby improving the safety of piston cooling and the simplicity of supporting member installation.

The technical solution of the present invention does not have high requirement for subsequent process of the piston, so that the heat treatment process can be selected to eliminate the welding stress.

### DESCRIPTION OF DRAWINGS

To more clearly describe the technical solution in the embodiments of the present invention or in the prior art, the drawings required to be used in the description of the embodiments or the prior art will be simply presented below. Apparently, the drawings in the following description are merely the embodiments of the present invention, and for those ordinary skilled in the art, other drawings can also be obtained according to the provided drawings without contributing creative labor.

FIG. 1 is a section view of a piston provided in the present invention;

FIG. 2 is a bottom view of a piston provided in the present invention;

FIG. 3 is an enlarged view of A place in FIG. 1 (supporting member not shown);

FIG. 4 is a structural schematic diagram of a supporting member of a piston provided in the present invention; and

FIG. 5 is an enlarged view of A in the corresponding position in FIG. 1, which has a reference example structure for test research.

### DETAILED DESCRIPTION

The technical solution in the embodiments of the present invention will be clearly and fully described below in combination with the drawings in the embodiments of the present invention. Apparently, the described embodiments are merely part of the embodiments of the present invention, not all of the embodiments. Based on the embodiments in the present invention, all other embodiments obtained by those ordinary skilled in the art without contributing creative labor will belong to the protection scope of the present invention.

The present invention provides a piston structure, and has advantages of reasonable structure and convenient processing, so that the reliability of the supporting member of the cooling oil cavity in the piston is increased, thereby improving the safety of the piston in use.

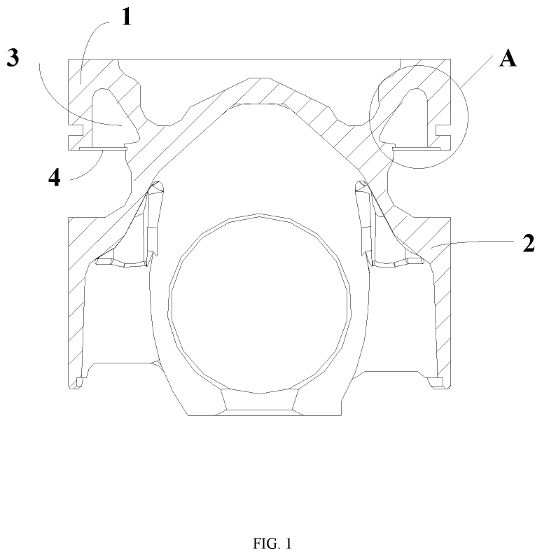

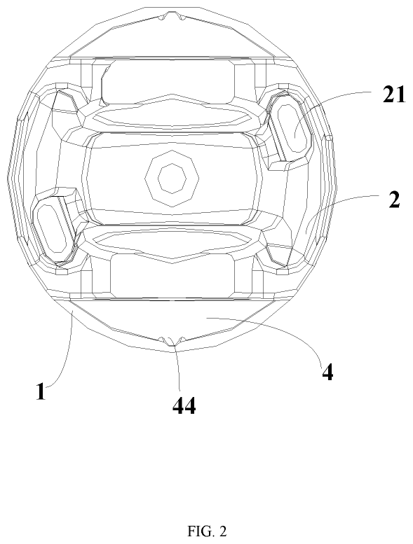

By referring to FIGS. 1 to 2, a piston is provided in the present invention, and the application thereof is not limited to vehicle motor, but is also used for a ship engine, a generating unit and the like; and the piston comprises a piston head 1 and a piston skirt 2 connected with the piston head; a cooling oil cavity 3 is arranged in the piston head 1, a position of the bottom of the cooling oil cavity 3 close to the piston skirt 2 is an open end 5, and the open end 5 is sealed through a supporting member 4; a cooling oil inlet 43 and an oil drain port 42 are arranged on the supporting member 4; the cooling oil inlet 43 is in communication with the cooling oil cavity 3 and an oil inlet channel 21 of the cooling oil arranged in the piston skirt 2; the oil drain port 42 is in communication with the cooling oil cavity 3 and the oil drain channel arranged in the piston skirt 2; and at least part of the open end 5 and the supporting member 4 are welded.

The present invention discloses a piston, wherein the open end 5 is arranged on the piston head 1, a sealed cavity is formed by the open end 5 and the supporting member 4, and the cooling oil inlet 43 and the oil drain port 42 are arranged on the supporting member 4; the cooling oil inlet 43 is in communication with the cooling oil cavity 3 and the oil inlet channel 21; and the oil drain port 42 is in communication with the cooling oil cavity 3 and the oil drain channel, so that the sealing of the cooling oil cavity 3 is increased, thereby ensuring the cooling effect of the piston head 1; and however, the supporting member 4 and the open end 5 are welded into a whole, thereby making the supporting 4 and the piston head 1 as a whole, to prevent an engine from damage due to the fact that the supporting member 4 falls off; and at the same time the supporting member 4 plays the role of supporting the excircle 1 of the piston head due to the fact that the supporting member 4 and the piston head 1 are rigidly connected, thereby reducing the deformation of the piston head 1 during operation, and increasing the safety and the reliability of the piston operation.

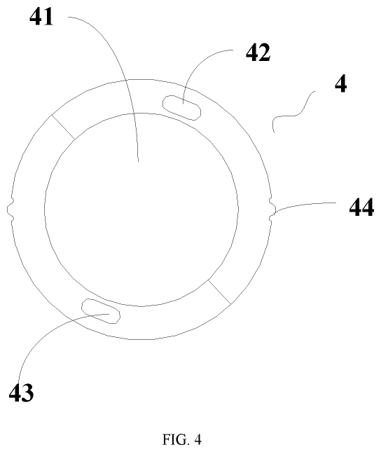

More specifically, by referring to FIG. 4, the supporting member 4 is a steel sheet, the steel sheet is closed in the open end 5, and the steel sheet and the open end 5 are fully or partially welded into a whole, wherein the steel sheet is enclosed by two semi-circular steel sheets. By means of the technical solution, it is beneficial to assemble the supporting member 4.

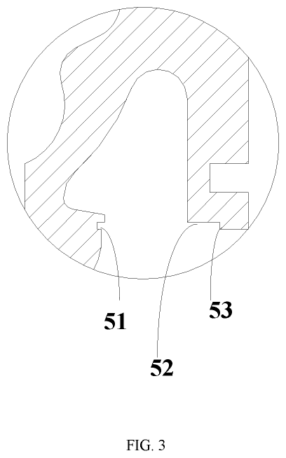

In one embodiment of the present invention, by referring to FIG. 3, the open end 5 comprises an inner clamping groove 51 in a horizontal position as well as an outer notch 53 formed by a vertical step surface and a horizontal step surface 52;

the steel sheet 4 is enclosed by two semi-circular steel sheets, and a mounting hole 41 is formed in the middle of two steel sheets; an inner side is clamped in the inner clamping groove 51, and the inner side and the inner clamping groove are welded;

an outer side of the steel sheet and the vertical step surface are welded; and

the horizontal step surface 52 and one side surface of the steel sheet are welded.

By means of the technical solution, it is beneficial to install the supporting member 4, and the supporting member 4 has three stops, thereby increasing the contact area of the supporting member 4 and the piston head 1, improving the assembly accuracy and easily forming an enclosed cavity.

wherein the matching clearance between the bottom of the inner clamping groove 51 and the inner side of the steel sheet is 0 to 0.2 mm, and the matching clearance between the width of the inner clamping groove and the thickness of the steel sheet is 0.05 to 0.15 mm; and the matching clearance of the step surface and the top of the steel sheet is 0.2 to 1 mm. Through the limit of the above matching clearance, the installation requirements for the supporting member 4 and the piston head 1 are ensured, which further provides the prerequisite for welding, thereby increasing the qualified product rate of the assembled supporting member 4. However, the matching clearance between the steel sheet and the vertical step surface is not high, which can be closed by post welding.

In all embodiments of the present invention, the piston head 1 and the piston skirt 2 are integrally connected or separately connected. The piston can be an integral forged steel piston or a steel crown aluminum skirt piston.

The welding mode is continuous welding and multiple-spot welding. The welding of the supporting member 4 and the open end 5 in the present invention can be completed by adopting any kind of welding (brazing, laser welding, etc.); and an identical or similar solution that the supporting member 4 and the piston head 1 are welded into a whole recorded in the present invention shall be fell into the protection scope of the present invention.

The supporting member 4 is made by machining or stamping; and the technical solution of the present invention does not have high requirement for the forming of the supporting member 4, which can adopt different processing methods, thereby reducing the processing cost of the supporting member 4.

The cooling oil cavity 3 is made by machining or precision casting. The technical solution of the present invention only needs to process the open end 5 in the piston head 1, which does not influence an original processing method for the piston head 1 and has strong universality.

The present invention also provides a support method for a piston ring groove, comprising the following steps:

S1. processing the supporting member with corresponding size according to the size of the open end of the piston; wherein the supporting members are provided with a cooling oil inlet and an oil drain port; wherein the size of the open side comprises an inner diameter, an outer diameter and height dimension of the open end; the open end can be processed according to pistons with different types, so that the size of the supporting member matched with the open end can be also changed correspondingly; and the size of the cooling oil inlet and drain port need be the same as the oil inlet channel and the oil drain channel of the piston;

S2. installing the supporting member processed in S1 in the open end to ensure that the cooling oil inlet is in communication with the cooling oil cavity and the oil inlet channel; and the oil drain port is in communication with the cooling oil cavity and the oil drain channel, thereby ensuring correct mounting position of each oil hole, that is, locating the mounting position of the supporting member in the piston head to prepare for subsequent welding;

S3. fully or partially welding the supporting member and the open end assembled in S2; and

S4. conducting heat treatment on the supporting member and the open end welded in S3.

In a sealing method for the cooling oil cavity of the piston disclosed in the present invention, the size of the supporting member is processed according to the size of the open end arranged on the piston head; and the supporting members are installed by positioning the oil inlet and the oil drain port to increase the positioning accuracy during the installation process; thereby improving the sealing of the cooling oil cavity and ensuring the cooling effect of the piston head; and however, the supporting member and the open end are welded into a whole, thereby making the supporting member and the piston head as a whole, to prevent an engine from damage due to the fact that the supporting member falls off; and at the same time the supporting member plays the role of supporting the excircle of the piston head due to the fact that the supporting member and the piston head are rigidly connected, thereby reducing the deformation of the piston head during operation and increasing the safety and the reliability of the piston operation.

Advantageously, the welds formed by welding are formed at an abutment junction between a mounting hole side and an inner clamping groove, a junction between the outside of the supporting member and an outer notch, and an abutment junction between steps and the top of the supporting member.

Therefore, the welding position of the present invention is arranged on the outside of the cooling oil cavity, which does not have high requirement. The welding can adopt continuous welding and multiple-spot welding, so that the difficulty level of the welding is reduced, thereby reducing the welding cost; and the welds are not in contact with the cooling oil, so that the welds do not need to be cleaned, thereby improving the safety of piston cooling and the simplicity of supporting member installation.

The technical solution of the present invention does not have high requirement for subsequent process of the piston, so that the heat treatment process can be selected to eliminate the welding stress.

To sum up, the technical solution of the present invention plays a role of supporting an outer circumstance of the piston head and preventing an engine from damage due to the fact that the supporting member falls off; and a convex structure is arranged on an outer circumstance of the supporting member, and the convex structure is fitted with the pit arranged in an inner side of the open end, so that the oil inlet of the supporting member corresponds to the position of a cooling nozzle of the engine, and oil inlet of the cooling oil cavity is ensure, thereby ensuring the cooling of the piston head. The technical solution of the present invention is simple in structure, easy to achieve, and fitted with promotion application of sealing the cooling oil cavity of the piston, so that the sealing of the cooling oil cavity is increased, thereby increasing the cooling effect of the piston head and ensuring normal operation of the piston head; however, the supporting member and the piston head are welded into a whole, and whether the supporting member is machined or stamped, the installation requirements can be ensured, and after welding, the supporting member and the piston head are firmly integrated, to prevent the supporting member from falling off and the piston from damage, thereby improving the operation safety of the engine. In addition, the supporting member plays the role of supporting the piston head and the ring groove of the piston head due to the fact that the supporting member and the piston head are rigidly connected, so that the deformation at the piston ring groove is reduced, thereby reducing the safety risk of the piston generated by excessive deformation.

Test Research 1:

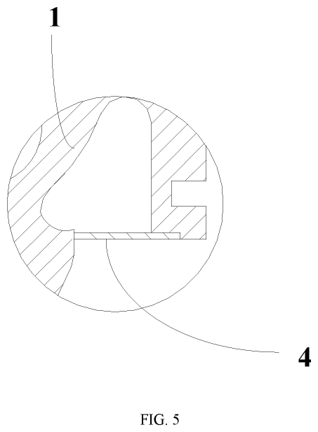

First group test: the supporting member adopts the structure in FIG. 4; for the welding positions of the supporting member and the piston head in embodiment 1, see the structure in FIG. 3 (incircle surface+excircle surface+top plane of the supporting member; the clamping groove is arranged in the position where the piston head is abutted against the incircle surface of the supporting member; and the welding is conducted on the clamping groove); for the welding positions of the supporting member and the piston head adopted in reference example 1, see the structure in FIG. 3 (incircle surface+external circular surface+top plane of the supporting member; and there is no clamping groove in the position where the piston head is abutted against the incircle surface of the supporting member); for the welding positions of the supporting member and the piston head adopted in reference example 2, see the structure in FIG. 3 (incircle surface+excircle surface+top plane of the supporting member; the clamping groove is arranged in the position where the piston head is abutted against the incircle surface of the support member; and the welding is not conducted on the clamping groove); For the welding positions of the supporting member and the piston head adopted in reference example 3, see the structure in FIG. 5 (incircle surface+excircle surface of the supporting member; and there is no clamping groove); in reference example 4, the supporting member and the piston head are elastically installed, and have non-welded structure; and

the pistons in five embodiments are respectively assembled into the consistent engine for reliability test. The reliability test is carried out in the whole vehicle, and the test duration is set at 25,000 h; and then the installation firmness, etc., of the supporting member is checked; it should be noted that the above tests of the present invention are batch tests, and the number of samples in each group shall be at least 10; and the test data are reflected as the average of the above test samples.

See the following Table 1:

| | | | | | | Whether a | | | |
|---|---|---|---|---|---|---|---|---|---|
| | Whether a | | | | | clamping | | | |
| | supporting | | | Whether | | groove is | | Whether the | |
| | member is | Whether | Welding | the | Maximum | arranged | | engine fails | |
| | provided | the | positions | supporting | deformation | in an inner | Running | (times) due | |
| | with a | dislocation | of the | member | (mm) of a | side of the | time (h) | to working | Difficulty |
| | convex | (mm) | supporting | (piece) | piston ring | supporting | of an | reliability | level of |
| | structure | occurs | member | falls off | groove | member | engine | of the piston | welding |
| Embodiment | Yes | 0.2 | Incircle | 0 | 0.17 | Have | 25000 | 0 | Simple |
| 1 | | | surface + | | | | | | |
| | | | excircle | | | | | | |
| | | | surface + | | | | | | |
| | | | plane | | | | | | |
| Embodiment | Yes | 0.2 | Incircle | 1 | 0.17 | None | 22300 | 2 | Difficult |
| 2 | | | surface + | | | | | | |
| | | | excircle | | | | | | |
| | | | surface + | | | | | | |
| | | | plane | | | | | | |
| Embodiment | Yes | 0.2 | Excircle | 1 | 0.20 | Have | 24000 | 1 | Simple |
| 3 | | | surface + | | | | | | |
| | | | plane | | | | | | |
| Reference | Yes | 0.2 | Incircle | 1 | 0.20 | None | 23500 | 2 | Difficult |
| example 1 | | | surface + | | | | | | |
| | | | excircle | | | | | | |
| | | | surface | | | | | | |
| Reference | Yes | 0.2 | Weldless | 3 | 0.25 | None | 20000 | 4 | |
| example 2: | | | | | | | | | |

It can be known from the first set of correlation data that a solution that the supporting member is provided with a convex structure, the structure in embodiment 1 is the same as that in embodiment 3, but the adopted welding positions are different to directly result in the falling off of the supporting member in embodiment 3, and the deformation at the piston ring groove is larger than that in embodiment 1 so that the probability of the engine failure is more than that in embodiment 1 is adopted;

The difference between embodiment 2 and embodiment 3 is that whether there are welding positions of a clamping groove as well as a supporting member and a piston head, and compared with embodiment 1, it is impossible to locate welding due to the lack of the clamping groove in embodiment 2, so that the welding is more difficult; and the weld quality is influenced, which results in falling off of one sample and engine failure;

The difference between reference example 1 and the above three embodiments is that the welding positions are an incircle surface and an excircle surface of the supporting member, and the difference between reference example 1 and embodiment 1 is that there is no clamping groove, so that the welding is more difficult; and the weld quality is influenced, which results in falling off of one sample and engine failure;

The difference between reference example 2 and the above four embodiments is that the welding mode is not adopted in reference example 2, and only the supporting member is installed into the piston head through elastic deformation; and but the supporting member is easy to fall off, which results in rapid increasing of the engine failure probability.

Second group test: supporting members adopt non-convex structure on an excircle. For the welding positions of the supporting member and the piston head in embodiment 4, see the structure in FIG. 3 (incircle surface+excircle surface+top plane of the supporting member; the clamping groove is arranged in the position where the piston head is abutted against the incircle surface of the supporting member; and the welding is conducted on the clamping groove); For the welding positions of the supporting member and the piston head adopted in reference example 5, see the structure in FIG. 5 (incircle surface+excircle surface of the supporting member; and there is no clamping groove); For the welding positions of the supporting member and the piston head adopted in reference example 6, see the structure in FIG. 3 (incircle surface+excircle surface+top plane of the supporting member; and there is no clamping groove in the position where the piston head is abutted against the incircle surface of the supporting member); For the welding positions of the supporting member and the piston head adopted in reference example 3, see the structure in FIG. 3 (incircle surface+excircle surface+top plane of the supporting member; the clamping groove is arranged in the position where the piston head is abutted against the incircle surface of the supporting member; and the welding is not conducted on the clamping groove); in reference example 4, the supporting member and the piston head are elastically installed, and have non-welded structure; and

the pistons in five embodiments are respectively assembled into the consistent engine for reliability test. The reliability test is carried out in the whole vehicle, and the test duration is set at 25,000 h; and then the installation firmness, etc., of the supporting member is checked; it should be noted that the above tests of the present invention are batch tests, and the number of samples in each group shall be at least 10; and the test data are reflected as the average.

See the following Table 2:

| | | | | | | Whether a | | | |
|---|---|---|---|---|---|---|---|---|---|
| | Whether a | | | | | clamping | | | |
| | supporting | | | Whether | | groove is | | Whether the | |
| | member is | whether | | the | Maximum | arranged | | engine fails | |
| | provided | the | | supporting | deformation | in an inner | Running | (times) due | |
| | with a | dislocation | | member | (mm) of a | side of the | time (h) | to working | Difficulty |
| | convex | (mm) | Welding | (piece) | piston ring | supporting | of an | reliability | level of |
| | structure | occurs | positions | falls off | groove | member | engine | of the piston | welding |
| Embodiment | None | 2 | Incircle | 0 | 0.17 | Have | 24880 | One piston is | Simple |
| 4 | | | surface + | | | | | not completely | |
| | | | excircle | | | | | cooled, and the | |
| | | | surface + | | | | | head has carbon | |
| | | | plane | | | | | deposit. | |
| Embodiment | None | 2 | Incircle | 0 | 0.17 | None | 24600 | One piston head | Difficult |
| 5 | | | surface + | | | | | is not completely | |
| | | | excircle | | | | | cooled, the head | |
| | | | surface + | | | | | has carbon deposit, | |
| | | | plane | | | | | and one ring groove | |
| | | | | | | | | has carbon deposit. | |
| Embodiment | None | 2 | Excircle | 1 | 0.20 | Have | 22000 | Two, wherein one | Simple |
| 6 | | | surface + | | | | | piston head is | |
| | | | plane | | | | | not completely | |
| | | | | | | | | cooled, and the | |
| | | | | | | | | engine power is | |
| | | | | | | | | low. | |
| Reference | None | 2 | Incircle | 1 | 0.17 | None | 20000 | Two, wherein one | Difficult |
| example 3: | | | surface + | | | | | engine has piston | |
| | | | excircle | | | | | scuffing. | |
| | | | surface | | | | | | |
| Reference | None | 2 | Weldless | 2 | 0.25 | Have | 23000 | One piston head | |
| example 4: | | | | | | | | is not completely | |
| | | | | | | | | cooled, and one | |
| | | | | | | | | engine power is | |
| | | | | | | | | low. | |

It can be known from the second set of correlation data that a solution that the supporting member is not provided with a convex structure on an excircle, the structure in embodiment 4 is the same as that in embodiment 6, but the adopted welding positions are different to directly result in the falling off of the supporting member in embodiment 6, and the deformation at the piston ring groove is larger than that in embodiment 4 so that the probability of the engine failure is more than that in embodiment 4 is adopted; Compared with a solution in the first group that the excircle of the supporting member is provided with a convex structure, there is a greater risk of damage to an engine;

The difference between embodiment 5 and embodiment 6 is that whether there are welding positions of a clamping groove as well as a supporting member and a piston head, and compared with embodiment 4, it is impossible to locate welding due to the lack of the clamping groove in embodiment 5, so that the welding is more difficult; and the weld quality is influenced, which results in one engine failure due to the fact that the piston head is not completely cooled and has carbon deposit, and the ring groove has carbon deposit;

The difference between reference example 3 and the above three embodiments is that the welding positions are an incircle surface and an excircle surface of the supporting member, and the difference between reference example 3 and embodiment 4 is that there is no clamping groove, so that the welding is more difficult; and the weld quality is influenced, which results in falling off of one sample and failure of two engines, wherein one engine has piston scuffing;

The difference between reference example 4 and the above four embodiments is that the welding mode is not adopted in reference example 4, and only the supporting member is installed into the piston head through elastic deformation; and however, the supporting member is easy to fall off, so that one engine piston head is not completely cooled, and one engine power is low.

Test Research 2:

Through the finite element analysis conclusion: the deformation analysis of simulation engine steady state piston ring groove is respectively conducted on a sample with a structure in embodiment 1 and a sample with a structure in reference example 2, and the explosive pressure is set as 24 Mpa; See the following Table 3:

TABLE 3
Finite Element Analysis Data

| | Welding | | Maximum | Minimum | Average |
|---|---|---|---|---|---|
| | positions of | | deformation | deformation | deformation |
| | the supporting | Explosive | (mm) of | (mm) of | (mm) of |
| | member and the | pressure | piston ring | piston ring | piston ring |
| | piston head | Mpa | groove | groove | groove |
| Embodiment 1 | Incircle surface + | 24 | 0.171 | 0.137 | 0.15 |
| | excircle surface + | | | | |
| | plane | | | | |
| Embodiment 2 | None | 24 | 0.252 | 0.203 | 0.221 |

Through the above finite element analysis conclusion: a sample of a structure of embodiment 1 is compared with a sample of a structure of embodiment 2: the supporting member in embodiment 1 is completely integrated with the piston body, and the deformation of piston ring groove is relatively small; In embodiment 2, the cooling oil channel is closed through the elastic steel sheet, the elastic steel sheet is thinner and has no support effect, the deformation of the ring groove is large, especially for a first ring groove, the first ring groove deformation is large, so that the phenomena that the piston sealing is not good, the gas will flow to the piston skirt when the engine works, there is insufficient power in the engine, the temperature of the piston head and the skirt is increased, and the engine scuffing appears are caused.

To sum up, from the test data, it can be seen that the solution adopted in the present invention is an optimal technical solution that the supporting member is provided with a convex structure and three welding places matched with the supporting member, which not only results in the small ring groove deformation, and also effectively prevents the supporting member from falling off, and reduces the welding difficulty. Meanwhile, the engine that adopted the solution has no failure due to the sealing of the piston cooling oil cavity. The solution is also a unique solution that the average operation duration meets thresholds that the test sets.

Each embodiment in the description is described in a progressive way. The difference of each embodiment from each other is the focus of explanation. The same and similar parts among all of the embodiments can be referred to each other. For a device disclosed by the embodiments, because the device corresponds to a method disclosed by the embodiments, the device is simply described. Refer to the description of the method part for the related part.

The above description of the disclosed embodiments enables those skilled in the art to realize or use the present invention. Many modifications to these embodiments will be apparent to those skilled in the art. The general principle defined herein can be realized in other embodiments without departing from the spirit or scope of the present invention. Therefore, the present invention will not be limited to these embodiments shown herein, but will conform to the widest scope consistent with the principle and novel features disclosed herein.

1. A piston, comprising:
a piston head; and
a piston skirt connected with the piston head;
a cooling oil cavity is arranged in the piston head; a position of the bottom of the cooling oil cavity close to the piston skirt is an open end, and the open end is used for supporting a piston ring groove and an excircle through a supporting member; a cooling oil inlet and an oil drain port are arranged on the supporting member; the cooling oil inlet is in communication with the cooling oil cavity and an oil inlet channel of the cooling oil arranged in the piston skirt; the cooling oil inlet is in communication with the cooling oil cavity and an oil drain channel arranged in the piston skirt; and
at least part of the open end and the supporting member are welded.

2. The piston of claim 1, wherein the supporting member is a steel sheet; the steel sheet is closed in the open end; and the steel sheet and the open end are fully or partially welded into a whole.

3. The piston of claim 2, wherein the open end comprises an inner clamping groove in a horizontal position and an outer notch formed by a vertical step surface and a horizontal step surface;
the steel sheet is annular, and an inner side of the steel sheet is clamped in the inner clamping groove, is matched with the inner clamping groove and then is welded;
an outer side of the steel sheet and the vertical step surface are welded; and
the horizontal step surface and one side surface of the steel sheet are welded;
wherein the steel sheet has a thickness of 2 to 4 mm.

4. The piston of claim 3, wherein the matching clearance between the bottom of the inner clamping groove and the inner side of the steel sheet is 0 to 0.2 mm, and the matching clearance between the width of the inner clamping groove and the thickness of the steel sheet is 0.05 to 0.15 mm; and the matching clearance between the step surface and the top of the steel sheet is 0.2 to 1 mm.

5. The piston of claim 3, wherein at least one pit is arranged in the open end; and a convex structure fitted with the pit is arranged on the outer circumference of the steel sheet.

6. The piston of claim 1, wherein the at least part of the open end and the supporting member are welded through continuous welding or multiple-spot welding.

7. The piston of claim 1, wherein the supporting member is made by machining or stamping.

8. The piston of claim 1, wherein the cooling oil cavity is made by machining or precision casting.

9. A support method for a piston ring groove, comprising the following steps:
S1. processing the supporting member with corresponding size according to the size of the open end of the piston, wherein the supporting member is provided with a cooling oil inlet and an oil drain port;
S2. installing the supporting member processed in S1 in the open end to ensure that the cooling oil inlet is in communication with the cooling oil cavity and the oil inlet channel; and the oil drain port is in communication with the cooling oil cavity and the oil drain channel;
S3. fully or partially welding the assembled supporting member and the open end in S2; and
S4. conducting heat treatment on the supporting member and the open end welded in S3.

10. The support method for a piston ring groove of claim 9, wherein welds formed through the above steps are formed at an abutment junction between a mounting hole side and an inner clamping groove, a junction between the outside of the supporting member and an outer notch, and an abutment junction between steps and the top of the supporting member.
